(19) United States
(12) Patent Application Publication
(10) Pub. No.: US 2019/0140312 A1
(43) Pub. Date: May 9, 2019

(54) SOLID-STATE IONIC CONDUCTORS AND METHODS OF MAKING THE SAME

(71) Applicant: Purdue Research Foundation, West Lafayette, IN (US)

(72) Inventors: Shriram Ramanathan, West Lafayette, IN (US); Yifei Sun, West Lafayette, IN (US)

(73) Assignee: Purdue Research Foundation, West Lafayette, IN (US)

(21) Appl. No.: 16/178,503

(22) Filed: Nov. 1, 2018

Related U.S. Application Data
(60) Provisional application No. 62/582,184, filed on Nov. 6, 2017.

(51) Int. Cl. H01M 10/0562; H01M 10/0525

(52) U.S. Cl. CPC H01M 10/0562; H01M 2300/0074; H01M 10/0525

(57) ABSTRACT

A solid-state ionic conductor. The solid-state ionic conductor contains a correlated perovskite into which ions and electrons are inserted giving rise to ionic conductivity. The inserted ions occupy interstitial lattice sites of the correlated perovskite, reduce the electronic conductivity of the correlated perovskite. A method of producing a solid-state ionic conductor. The method includes forming a thin film containing a transition metal X, a rare earth element R and oxygen (O) by co-depositing the transition metal and the rare earth element on a substrate in an oxygen-containing atmosphere. The thin film is then annealed at an annealing temperature for a period of time in an oxygen containing atmosphere, resulting in formation of a crystalline film of RXO₃. Ions and electrons from an ion source are then inserted into the crystalline film of RXO₃, resulting in a solid-state ionic conductor.

### CROSS-REFERENCE TO RELATED APPLICATIONS

The present U.S. patent application is related to and claims the priority benefit of U.S. Provisional Patent Application Ser. No. 62/582,184, filed Nov. 6, 2017, the contents of which are hereby incorporated by reference in their entirety into the present disclosure.

### STATEMENT REGARDING GOVERNMENT FUNDING

This invention was made with government support under DMR1609898 awarded by National Science Foundation. The government has certain rights in the invention.

### TECHNICAL FIELD

The present application relates to solid-state conductors, especially solid-state lithium-ion conductors and methods of making them.

### BACKGROUND

This section introduces aspects that may help facilitate a better understanding of the disclosure. Accordingly, these statements are to be read in this light and are not to be understood as admissions about what is or is not prior art.

Secondary (rechargeable) lithium-ion batteries (LIBs), such as lithium-sulfur batteries (Li—S), and lithium-air batteries (LABs) with high energy-density are in increasingly great demand in the world. So far, liquid electrolytes are still ubiquitous due to their superior performances. However, a flammable and corrosive liquid electrolyte can easily cause ignition and explosion. As the potential replacement, inorganic solid-state lithium-ion conductors (SSLICs) with enhanced thermal and mechanical stability and promoted safety advantages have potential to clean up the barrier for their booming large-scale developments in diverse fields including sensors, microbatteries or power support for electrical vehicles.

Generally, besides some typical nitride and phosphide based electrolytes, the SSLiCs are mainly classified into two types including oxides and sulfides. And diverse kinds of materials have been discovered and developed as potential electrolytes including thio-LISICON (Li₁₄Zn(GeO₄)₄), amorphous LiPON argyrodite type conductor (Li₆PS₅X (X═Cl, Br)), Li_{0.34}La_{0.51}TiO_{2.94} (LLTO) with perovskite structure, Li_{6.55}La₃Zr₂Ga_{0.15}O₁₂ with garnet-type structure and Li₁₀GeP₂S₁₂ which shows comparable performance to commercial LiBF₄/EMIBF₄ ionic liquids electrolyte.

The most general approach to fabricate SSLICs oxides involves the well mixing of stoichiometric solid precursor powders and following manufacturing methodologies. In the meanwhile, some of them also could be prepared through deposition methods including pulsed laser deposition (PLD), or atomic layer deposition (ALD) to realize thin film electrolyte. The preparation procedure of sulfide-based SSLICs is similar to that of oxides. However, it always requires more critical fabrication condition (such as ambient moisture) to avoid potential decomposition of sulfide precursor, such as Li2S and P2S5. Some anti-perovskites type SSLICs are required to be melted at a high temperature (200-300° C.) first in inert gas environment before synthesis. And the nitrides, such as Li₃N and its derivatives were usually synthesized through the reaction between molten metallic lithium and N₂ flow at targeted temperature. Also, some solid polymer electrolytes (SPE) are developed via a special approach in which mobile lithium salts are usually dissolved into polymer backbone.

To date compared to oxide-based SSLICs, the sulfide based SSLICs are much more difficult to synthesize and more sensitive to moisture environment. However, the weaker ionic conduction of oxide-based SSLICs is still an obstacle for their utilization. It is recognized that the perovskite-type LLTO have achieved an ionic conductivity of 10⁻⁴ S cm⁻¹ at 298 K. However, such conductivity is still poor to reach a technologically advantageous level (e.g., 10⁻³ S/cm at 25° C.). Thus there is an unmet need for improvements in lithium ion transport as well as the suppression of electronic conduction in solid oxide electrolytes to lead to promising applications.

### SUMMARY

A solid-state ionic conductor is disclosed. The solid-state ionic conductor contains a correlated perovskite into which ions and electrons are inserted giving rise to ionic conductivity. The inserted ions occupy interstitial lattice sites of the correlated perovskite, and the inserted electrons reduce the electronic conductivity of the correlated perovskite.

A method of producing a solid-state ionic conductor is disclosed. The method includes co-depositing a transition metal and a rare earth element on a substrate in an oxygen-containing atmosphere from two targets where in one of the targets comprises the transition metal and the other target comprises the rare earth element. The co-deposition results in the formation of a thin film containing the transition metal, the rare earth element and oxygen. The thin film resulting from the co-deposition step is then annealed at an annealing temperature for a period of time in an oxygen containing atmosphere. This results in the formation of a crystalline film of RXO₃ wherein R is the rare-earth element, X is the transition metal, and O is oxygen. Ions and electrons are then inserted from an ion source into the crystalline film of RXO₃, resulting in a solid-state ionic conductor.

### BRIEF DESCRIPTION OF DRAWINGS

Some of the figures shown herein may include dimensions. Further, some of the figures shown herein may have been created from scaled drawings or from photographs that are scalable. It is understood that such dimensions or the relative scaling within a figure are by way of example, and not to be construed as limiting.

FIG. 1 shows schematic representation of Li—RNiO₃ preparation strategy.

FIG. 2 shows a schematic representation of Na—RNiO₃ preparation strategy.

FIG. 3 shows lithiation induced sheet resistance evolution of the SNO (SNO═SmNiO₃) film.

FIG. 4 shows optical images demo starting transparency change Li—SNO as a function of lithiation time indicated in min.

FIG. 5 shows the temperature dependent evolution of ionic conductivity of Li—SNO thin film, compared with other typical LIC (LIC=Lithium Ion Conductor) candidates reported.

FIG. 6 shows the atomic percentages of nickel and samarium for SNO and for Li—SNO films prepared in experiments leading to this disclosure.

FIG. 7A shows a plot of peak signal intensity versus binding energy of Ni 2p_{3/2} in an XPS measurement of SNO and Li—SNO films of this disclosure.

FIG. 7B shows a plot of peak signal intensity versus binding energy of Li₁ₛ in an XPS measurement of SNO and Li—SNO films of this disclosure.

FIG. 8 shows the electronic resistivity evolution of SNO with different thicknesses upon lithiation for a period of 2 hours.

FIG. 9 shows stability of Li—SNO/LAO against air oxidation and humidity.

### DETAILED DESCRIPTION

For the purposes of promoting an understanding of the principles of the disclosure, reference will now be made to the embodiments illustrated in the drawings and specific language will be used to describe the same. It will nevertheless be understood that no limitation of the scope of the disclosure is thereby intended.

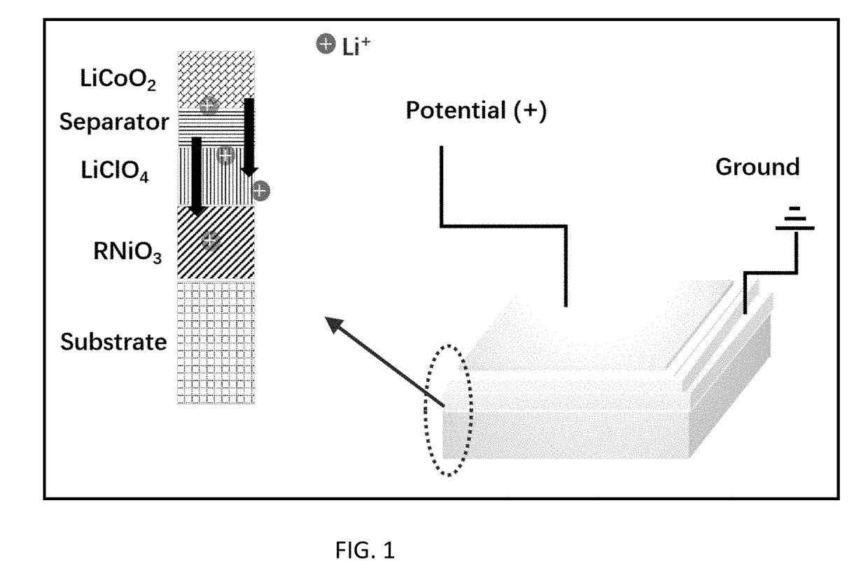

In this disclosure, a new class of solid-state lithium-ion conductors using perovskite nickelate materials and methods of making them are described. In experiments leading to this disclosure, modified liquid electrolyte based half-cell configurations are utilized to introduce Li⁺ into strongly correlated nickelate thin film materials. The term “electron correlation” in the context of understanding the term “electron-correlated nickelate” or simply “correlated nickelate” is well understood by those skilled in the art. The RNiO₃ film (R=lanthanide element, such as La, Sm, Nd, Eu) can be prepared by several different methods such as solid state sintering, sol-gel method, RF-sputtering, pulsed laser deposition (PLD), or atomic layer deposition (ALD) and molecular beam epitaxy (MBE) etc on diverse kind of substrates including LaAlO₃ (LAO), silicon (Si), and quartz etc. FIG. 1 shows schematic representation of Li—RNiO₃ preparation strategy of this disclosure. Referring to FIG. 1, LiCoO₂ is a source of lithium in the preparation strategy shown in FIG. 1. Other non-limiting lithium sources that can be used in this strategy include metallic lithium and other lithium containing materials. The separator in FIG. 1 can be tri-layer polypropylene-polyethylene-polypropylene membrane or other commercial lithium-ion battery separator film. The liquid lithium electrolytes (such as LiClO₄ in ethylene carbonate), polymer lithium ionic conductors, such as bis(trifluoromethane), sulfonamide lithium salt (LiTFSI) on ethylene glycol), or other lithium conductors could serve as electrolyte for the half-cell. For a typical preparation process, a quartz substrate (1 cm*1 cm*0.5 cm) is ultrasonically cleaned using toluene, acetone, and isopropanol solvent, respectively. And then, the substrate is cleaned with ultra-high purity Argon gas until dry before usage. The material SmNiO₃ is referred as SNO in this disclosure and is a typical example for RNiO₃. The film is deposited by magnetron sputtering technology using metallic Sm and metallic Ni as targets. The atmosphere used for the sputtering process was a mixture of argon and oxygen. A of 40 sccm Ar and 10 sccm O₂ at gas pressure of 5 mtorr was used. One typical non-limiting sputtering power of Sm and Ni targets are 160 Watt and 80 Watt, respectively. 45 min grown time can give the film thickness of 100 nm. The as-deposited SNO is subsequently placed in a stainless steel autoclave for annealing in 1400 psi ultra-high purity oxygen gas at 500° C. for 24 h to prepare the SNO with high crystallinity.

In experiments leading to this disclosure, ions and electrons are inserted into a perovskite nickelate structure. The insertion of ions requires a source of the ions. Exemplary ions suitable for the purpose include, but not limited to lithium ions. When lithium ions are used, the ion insertion process, for purposes of this disclosure is termed “lithiation”. For a typical lithiation process, a drop of LiClO₄ in ethylene carbonate (concentration of 1 mol per liter) liquid electrolyte is dispersed onto the SNO thin film and then a piece of LiCoO₂ on Aluminum foil (0.5 cm*0.5 cm) is placed above the electrolyte solution. A piece of Celgard 2500 separator (1 cm*1 cm) is soaked in electrolyte solution and placed between thin film and LiCoO₂ on Aluminum foil. A solid conductor is then formed while a positive bias of 3.0 V is applied between LiCoO₂ on Aluminum foil and SNO thin film for a certain period of time of 2 hours. In this disclosure SNO into which Li ions are inserted is denoted as Li—SNO. The insertion of lithium ions is termed lithiation. Thus lithiated SNO is denoted, throughout this disclosure as Li—SNO.

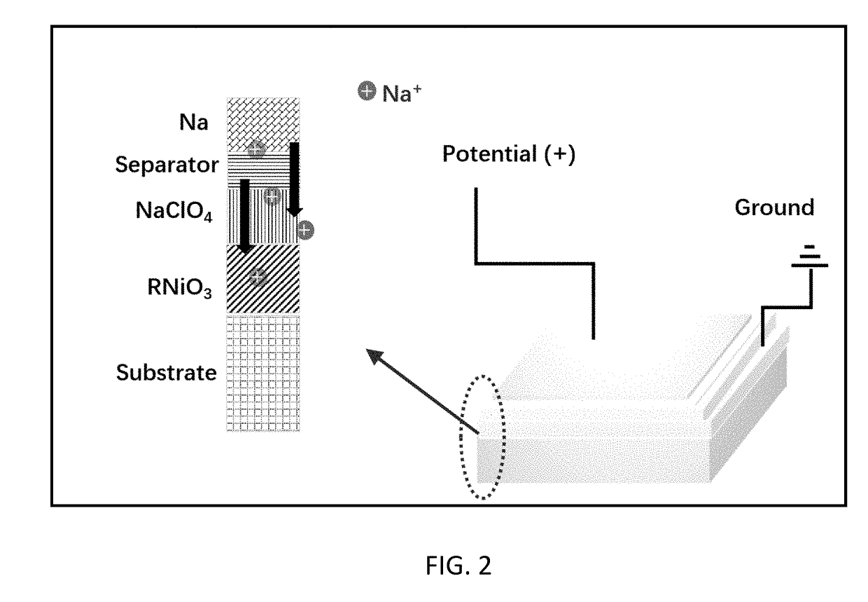

FIG. 2 shows a schematic representation of Na—RNiO₃ preparation strategy. Referring to FIG. 2, sodiation on RNiO₃ was performed by using the similar setup as lithiation strategy shown in FIG. 1. A metallic sodium (Na) disc and Na ionic conducting material (such as NaClO₄ in ethylene carbonate (concentration of 1 mol per liter) were chosen as Na resource and electrolyte, respectively as indicated in FIG. 2.

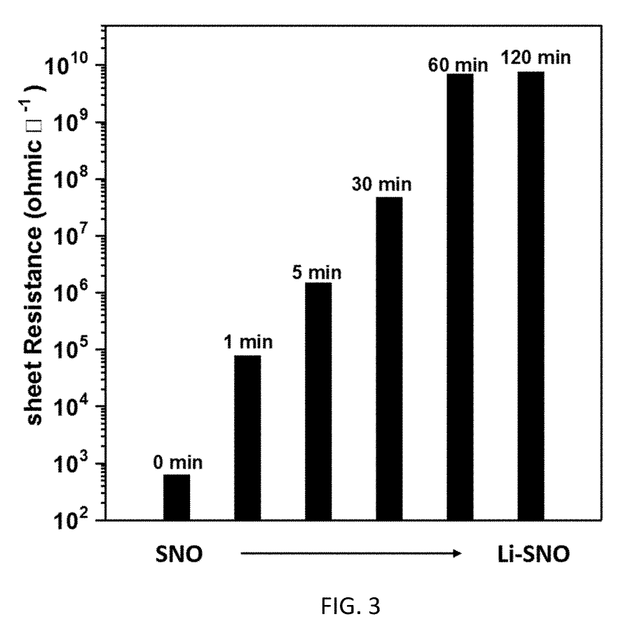

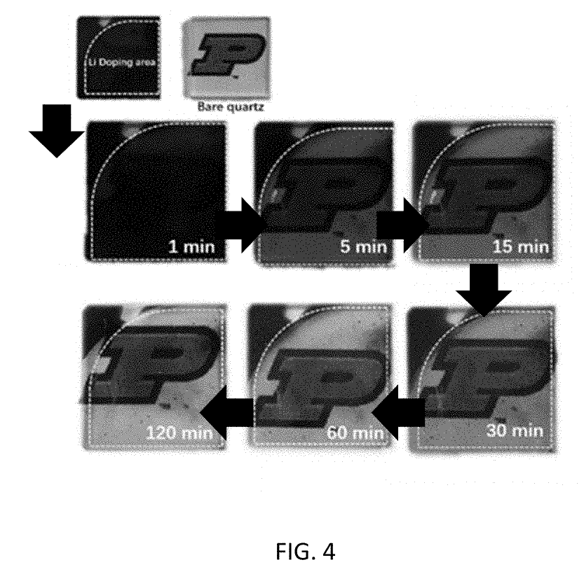

Using SNO as an example, the modulation of electronic transport properties of SNO/Quartz substrate upon lithiation were systematically examined by measuring sheet resistance of SNO. Results of these measurements are presented in FIG. 3. Referring to FIG. 3, SNO film on a quartz substrate with a thickness of 100 nm displayed low in-plane sheet resistance (electronic sheet resistance) close to 10³Ω per square prior to lithiation (indicated as 0 min in FIG. 3 By applying 3.0 V bias between lithium foil and SNO film, a 1 min lithiation time significantly enhanced the resistance by more than two orders of magnitude to 2*10⁵Ω per square, as shown in FIG. 3 Again referring to FIG. 1, as lithiation proceeds, the sheet resistance continues to dynamically increase to 10¹⁰Ω per square and then almost saturate (denoted as Li—SNO shown in FIG. 3), indicating a complete cut off of electron flow. The suppression of electronic conduction is the crucial prerequisite for promising SSLICs. The modulation of conductivity behavior can be primarily attributed to the filling of electron in 3d orbital of Ni to form strong electron repulsion. FIG. 4 shows optical images demonstrating transparency change of an SNO film with a thickness of 100 nm as a function of lithiation time indicated in min. Referring to FIG. 4, a piece of paper with an icon, namely, “Purdue”, as a non-limiting example, is placed underneath the substrate to demonstrate the optical property evolution of film upon lithiation. The bare quartz substrate is transparent and SNO film on quartz substrate is almost opaque. Significantly, lithiation makes the thin film become transparent and the icon labeled “Purdue” underneath could be clearly observed.

It should be recognized that the change in thickness of SNO due to lithiation is of the order 10% and the electronic resistance change in SNO due to lithiation is much more significant than electronic resistance changes occurring due to a thickness effect.

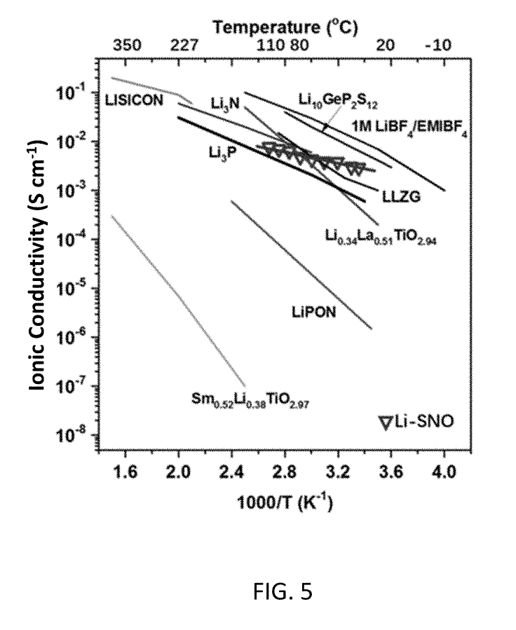

FIG. 5 shows the temperature dependent evolution of ionic conductivity of Li—SNO thin film, compared with other typical LICs candidates whose ionic conductivity is reported in literature. As a benchmark, the ionic liquid LiBF₄/EMIBF₄ exhibits ionic conductivity as high as 10⁻² (S cm⁻¹) at room temperature. The Li—SNO has a high ionic conductivity of 3.1*10⁻³ (S cm⁻¹) at 20° C., which is close to the current best SSLICs of Li₁₀GeP₂S₁₂ but superior to the best reported perovskite type SSLICs.

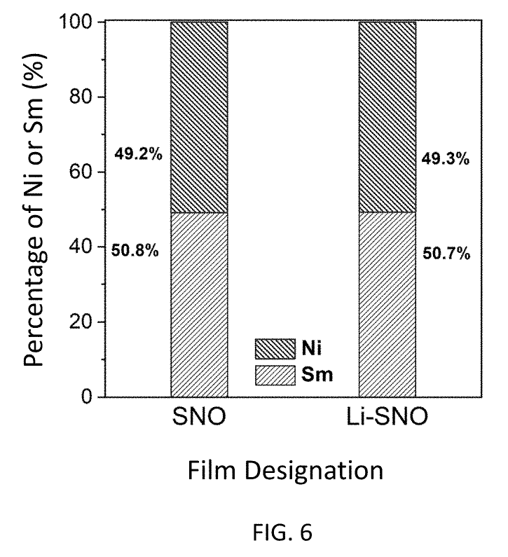

FIG. 6 shows the atomic percentages of nickel and samarium for SNO and for Li—SNO films prepared in experiments leading to this disclosure. These atomic percentages were obtained by Scanning electron microscopy with energy dispersive X-ray spectroscopy (SEM-EDX). Referring to FIG. 6, it is seen that lithiation shows no significant influence on the atomic percentages of nickel and samarium in the films which remain close to the ideal stoichiometry of SNO. This result suggests no occurrence of substitutional Li doping within the limits of the detection of the instrument. This indicates that the inserted lithium ions occupy the interstitial sites of SNO. It has been recognized that lithium ions occupy the interstitial sites of SNO.

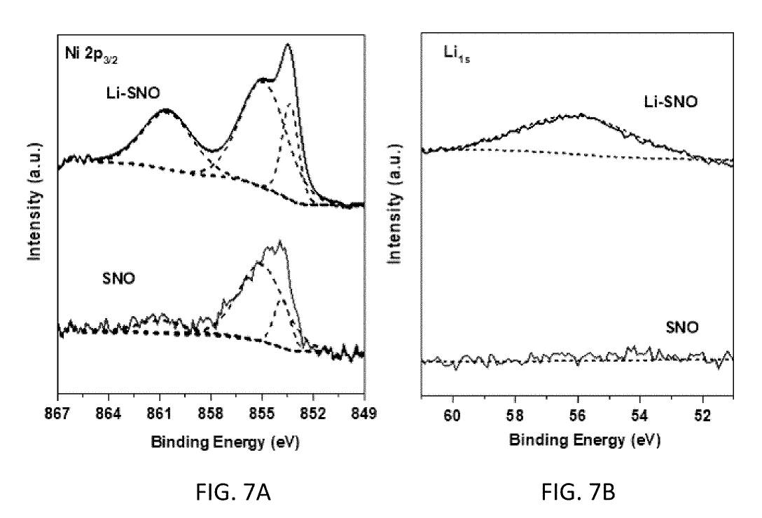

The electronic configuration evolution upon lithium intercalation were analyzed using X-ray photoelectron spectroscopy (XPS). FIGS. 7A and 7B show a plot of peak signal intensity versus binding energy of Ni 2p_{3/2} and Li₁ₛ respectively in an XPS measurement of SNO and Li—SNO films of this disclosure with a thickness of 100 nm. Clearly, in FIG. 7A, the major Ni(2p_{3/2}) peaks shift with respect to binding energy after lithiation, qualitatively suggesting the conversion of Ni³⁺ to Ni²⁺ upon lithiation. On the other hand, in FIG. 7B, the peak at the binding energy of at 56 eV can be ascribed to Li₁ₛ. The ratio of Li to Ni in Li—SNO is estimated to be 0.86/1.

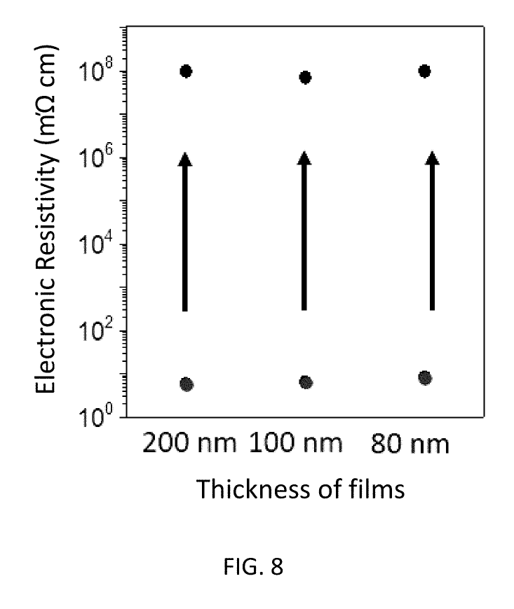

FIG. 8 shows the electronic resistivity evolution of SNO with different thicknesses upon lithiation for a period of 2 hours. All the samples studied with thickness of 80, 100 and 200 nm show the significant increase of resistance up to 7 orders of magnitude after 2 hours lithiation.

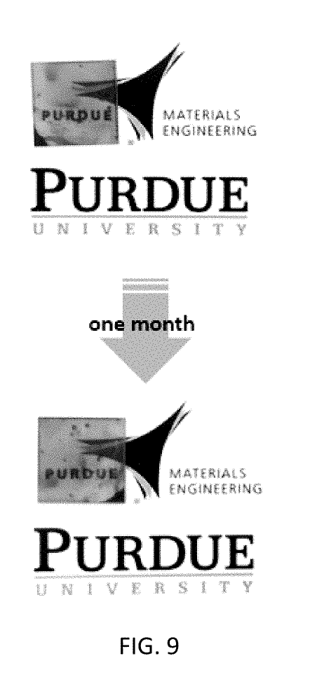

In addition, superior to incorporation of H into VO₂ or SNO reported before, such lithiation induced thin film modulation shows non-volatility with much better stability against air oxidation and humidity (FIG. 9). Referring to FIG. 9, The Li—SNO film sample was stored at room temperature in aplastic box without inert gas protection for one month. The film still shows visually transparent property and no obvious optical change can be observed. The sheet resistance of the film did not change as well, indicating its good stability.

This disclosure is not limited to solid-state lithium-ion conductor compositions of this and the described methods of making them. The approaches of this disclosure can be applied to other alkali-metal ion conductors. Non-limiting examples include solid-state ionic conductors based on sodium, magnesium and potassium. In experiments leading to this disclosure, results obtained on sodium doped SmNiO₃ showed that the in-plane sheet resistance increase from 10³Ω per square to 10⁸Ω per square after sodium doping for 2 hours at 3 V bias. This behavior is similar to that obtained with lithium doped SNO suggesting other light cations might be mobile in the nickelate lattice.

Based on the above description, it is an objective of this disclosure to describe a solid-state ionic conductor comprising a correlated perovskite into which ions and electrons are inserted giving rise to ionic conductivity. It is recognized that the ions, when inserted into a correlated perovskite, occupy interstitial lattice sites of the correlated perovskite. In this disclosure, interstitial site occupancy of lithium ions, as a non-limiting example, has been exploited to induce ionic conductivity and reduce the electronic conductivity of the correlated perovskite.

In some embodiments of the solid-state ionic conductor of this disclosure, the correlated perovskite material is of the form RXZ₃, where R is one or more of rare earth elements and X is one or more of transition metals, and Z is one or more of oxygen, sulfur and a halogen. An example of X is nickel. Other non-limiting examples of X suitable for the ionic conductors of this disclosure are cobalt and titanium. Suitable examples for R include, but not limited to the rare earth elements samarium (Sm), neodymium (Nd), and europium (Eu). The ions inserted into interstitial sites include, but not limited to, lithium ions, sodium ions, magnesium ions, potassium ions, hydrogen ions, and aluminum ions. In a preferred embodiment of the solid-state ionic conductor of this disclosure, R is samarium, X is nickel, and Z is oxygen, giving rise to the correlated perovskite SmNiO₃, denoted in this disclosure as SNO. In a preferred embodiment of this disclosure, lithium ions are inserted into SNO, giving rise to ionic conductivities in the range of 3×10⁻³ S cm⁻¹ to 1×10⁻² S cm⁻¹ in the temperature range of 20° C. to 100° C. In some embodiments of the solid-state ionic conductor of the disclosure, the surface roughness of the ionic conductor is in the range of 0.3-10.0 nm and the thickness of the solid-state ionic conductor is in the range of 1 nm-2000 nm.

It is another objective of this disclosure to describe a method of producing a solid-state lithium ion conductor. The method of producing a solid-state lithium ion conductor of this disclosure includes co-depositing a transition metal and a rare earth element on a substrate in an oxygen-containing atmosphere from two targets where in one of the targets comprises the transition metal and the other target comprises the rare earth element, the co-deposition forming a thin film comprising the transition metal, the rare earth element and oxygen, The resulting thin film is then annealed at an annealing temperature for a period of time in an oxygen containing atmosphere, resulting in formation of a crystalline film of RXO₃ wherein R is the rare-earth element, X is the transition metal, and O is oxygen. Ions and electrons are then inserted from an ion source via intercalation into the crystalline film of RXO₃, resulting in a solid-state ionic conductor. Intercalation into the crystalline film of RXO₃ can also be termed intercalation doping. Co-deposition methods suitable for the method of making the ionic conductor of this disclosure are known to those skilled in the art and include, but not limited to, sputtering, molecular beam epitaxy, chemical deposition, sol-gel processing, spray casting and pulsed laser deposition. Examples of rare earth elements suitable for the method of this disclosure include, but not limited to of samarium (Sm), neodymium (Nd), and europium (Eu). Non-limiting examples of ions suitable for insertion include lithium ions, sodium ions, magnesium ions, potassium ions, hydrogen ions, and aluminum ions. Non-limiting example of ion sources include Li and LiCoO₂ for inserting Li ions, and Na for inserting sodium ions. In one preferred embodiment of the method, the rare earth element is samarium and the transition metal is nickel. Annealing temperatures suitable for the method are in the range of 500-800° C. while the annealing periods can be in the range of 10-50 hours. In the oxygen containing atmosphere of the method, the partial pressure of oxygen is in the range of 1400-1700 psi. Substrates suitable for the method of this disclosure include, but not limited to, quartz, LaAlO₃, and Si.

In the method described above, both co-deposition and annealing were carried in an oxygen atmosphere. Formation of RXO₃ in the method of this disclosure can be accomplished even if one of the two steps, namely co-deposition and annealing, is carried out in an oxygen atmosphere.

While the present disclosure has been described with reference to certain embodiments, it will be apparent to those of ordinary skill in the art that other embodiments and implementations are possible that are within the scope of the present disclosure without departing from the spirit and scope of the present disclosure. Thus, the implementations should not be limited to the particular limitations described. Other implementations may be possible.

1. A solid-state ionic conductor comprising a correlated perovskite into which ions and electrons are inserted giving rise to ionic conductivity, wherein the inserted ions occupy interstitial lattice sites of the correlated perovskite, and wherein the inserted electrons reduce the electronic conductivity of the correlated perovskite.

2. The solid-state ionic conductor of claim 1, wherein the correlated perovskite material is of the form RXZ₃, where R is one or more of rare earth elements and X is one or more of transition metals, and Z is one or more of oxygen, sulfur and a halogen.

3. The solid-state ionic conductor of claim 2, X is nickel and Z is oxygen.

4. The solid-state ionic conductor of claim 3, where R is one of one of samarium (Sm), neodymium (Nd), and europium (Eu).

5. The solid-state ionic conductor of claim 1, where in the ions are one of lithium ions, sodium ions, magnesium ions, potassium ions, hydrogen ions, and aluminum ions.

6. The solid-state ionic conductor of claim 4, wherein the rare-earth element is samarium, and the inserted ions are lithium ions.

7. The solid-state ionic conductor of claim 6, wherein the ionic conductivity of the solid-state ionic conductor is in the range of 3×10⁻³ S cm⁻¹ to 1×10⁻² S cm⁻¹ in the temperature range of 20° C. to 100° C.

8. The solid-state ionic conductor of claim 1, wherein the surface roughness of the solid-state ionic conductor is in the range of 0.3-10.0 nm.

9. The solid-state ionic conductor of claim 1, wherein the thickness of the solid-state ionic conductor is in the range of 1 nm-2000 nm.

10. A method of producing a solid-state ionic conductor comprising:
co-depositing a transition metal and a rare earth element on a substrate in an oxygen-containing atmosphere from two targets where in one of the targets comprises the transition metal and the other target comprises the rare earth element, the co-deposition forming a thin film comprising the transition metal, the rare earth element and oxygen;
annealing the thin film comprising the transition metal, the rare earth element and oxygen at an annealing temperature for a period of time in an oxygen containing atmosphere, resulting in formation of a crystalline film of RXO₃ wherein R is the rare-earth element, X is the transition metal, and O is oxygen; and
inserting ions and electrons from an ion source into the crystalline film of RXO₃, resulting in a solid-state ionic conductor.

11. The method of claim 10, wherein the co-deposition is done by one of sputtering, molecular beam epitaxy, chemical deposition, sol-gel processing, spray casting and pulsed laser deposition.

12. The method of claim 10, wherein the rare earth element is one of samarium (Sm), neodymium (Nd), and europium (Eu).

13. The method of claim 10, wherein the ions are one of lithium ions, sodium ions, magnesium ions, potassium ions, hydrogen ions, and aluminum ions.

14. The method of claim 10, wherein they ion source is Li or LiCoO₂ and the inserted ions are lithium ions.

15. The method of claim 10, wherein they ion source is Na and the inserted ions are sodium ions.

16. The method of claim 10, where in the rare earth element is samarium and the transition metal is nickel.

17. The method of claim 10 wherein the annealing temperature is in the range of 500-800° C.

18. The method of claim 10, wherein the period of time is in the range of 10-50 h.

19. The method of claim 10, wherein the partial pressure of oxygen is in the range of 1400-1700 psi.

20. The method of claim 10, wherein the substrate is one of quartz, LaAlO3, and Si.
